(19) United States
(12) Patent Application Publication
(10) Pub. No.: US 2006/0092219 A1
(43) Pub. Date: May 4, 2006

(54) Methods and apparatus for aligning inkjet print head supports

(76) Inventors: Shinichi Kurita, San Jose, CA (US); Quanyuan Shang, Saratoga, CA (US)

Correspondence Address: DUGAN & DUGAN, PC, 55 SOUTH BROADWAY, TARRYTOWN, NY, 10591, US

(21) Appl. No.: 11/212,043

(22) Filed: Aug. 25, 2005

Related U.S. Application Data
(60) Provisional application No. 60/625,550, filed on Nov. 4, 2004.

(51) Int. Cl. B41J 2/15

(52) U.S. Cl. 347/40

(57) ABSTRACT

In some embodiments of the invention, a method for inkjet printing is provided. The method includes providing sets of print heads, each set being disposed along a different axis. The method also includes adjusting each axis relative to different display objects on a substrate. Numerous other aspects are provided.

### CROSS-REFERENCE TO RELATED APPLICATIONS

The present application claims priority to commonly-assigned, co-pending U.S. Provisional Patent Application Ser. No. 60/625,550, filed Nov. 4, 2004 and entitled “APPARATUS-AND METHODS FOR FORMING COLOR FILTERS IN A FLAT PANEL DISPLAY BY USING INKJETTING” which is hereby incorporated herein by reference in its entirety for all purposes.

The present application is related to the following commonly-assigned, co-pending U.S. Patent Applications, each of which is hereby incorporated herein by reference in its entirety for all purposes:

U.S. patent application Ser. No. 11/019,967, filed Dec. 22, 2004 and entitled “APPARATUS AND METHODS OF AN INKJET HEAD SUPPORT HAVING AN INKJET HEAD CAPABLE OF INDEPENDENT LATERAL MOVEMENT” (Attorney Docket No. 9521-1);

U.S. patent application Ser. No. 11/019,929, filed Dec. 22, 2004 and titled “METHODS AND APPARATUS FOR INKJET PRINTING.” (Attorney Docket No. 9521-2); and

U.S. patent application Ser. No. 11/019,930, filed Dec. 22, 2004 and entitled “METHODS AND APPARATUS FOR ALIGNING PRINT HEADS” (Attorney Docket No. 9521-3).

### FIELD OF THE INVENTION

The present invention relates generally to electronic device manufacturing and systems for printing, and is more particularly concerned with apparatus and methods for aligning inkjet print head supports for printing color filters.

### BACKGROUND OF THE INVENTION

The flat panel display industry has been attempting to employ inkjet printing to manufacture display devices, in particular, color filters. One problem with effective employment of inkjet printing is that it is difficult to dispense ink or other material accurately and precisely on a substrate while having high throughput.

### SUMMARY OF THE INVENTION

In some embodiments of the invention, a method for inkjet printing is provided. The method includes providing sets of print heads, each set being disposed along a different axis. The method also includes adjusting each axis relative to different display objects on a substrate.

In the same or another aspect of the invention, an apparatus for inkjet printing is provided. The apparatus includes sets of print heads supported on print head supports. The apparatus also includes a control mechanism adapted to allow adjustment of the print head supports to align with display objects on a substrate.

In the same or another aspect of the invention, a system for inkjet printing is provided. The system includes an inkjet printer with sets of print heads supported on print head supports. The system also includes a stage adapted to move display objects on a substrate relative to the print heads during printing and a frame coupled to the print head supports and adapted to stabilize the print head supports during printing.

Other features and aspects of the present invention will become more fully apparent from the following detailed description, the appended claims and the accompanying drawings.

### BRIEF DESCRIPTION OF THE DRAWINGS

FIG. 1A is a top view of an inkjet printing system according to some embodiments of the present invention.

FIG. 1B is a side view of an inkjet printing system according to some embodiments of the present invention.

FIG. 2 is a top view of an inkjet printing apparatus according to some embodiments of the present invention.

FIG. 3 is a flowchart illustrating an example of a method of inkjet printing according to some embodiments of the present invention.

FIG. 4 is a partial perspective view of an inkjet printing system in accordance with some embodiments the present invention.

### DETAILED DESCRIPTION

The present invention provides methods and apparatus for improving printing throughput in a printing system by providing enhanced control over print head movement and/or concurrent printing through multiple sets of print heads. According to the present invention, a set of print heads may be supported as a unit on an arm and arranged along a common axis, so as to allow the heads to concurrently dispense material onto a substrate as the substrate is transported below the heads. In some embodiments, multiple sets of print heads may each be arranged along different axes (e.g., supported on different arms). In addition, the sets of heads may be independently adjustable (e.g., rotated, pivoted, etc.) such that the axes may be aligned at different angles relative to each other and/or a reference. In other words, a control mechanism may allow adjustment of the angles of the axes with respect to the substrate or each other. In such embodiments, printing throughput may be improved by using the individual sets of print heads to dispense material concurrently. In additional and/or alternative embodiments, individual print heads within each set may be independently adjusted (e.g., rotated, pivoted, etc.) and/or shifted (e.g., moved longitudinally along the support arms).

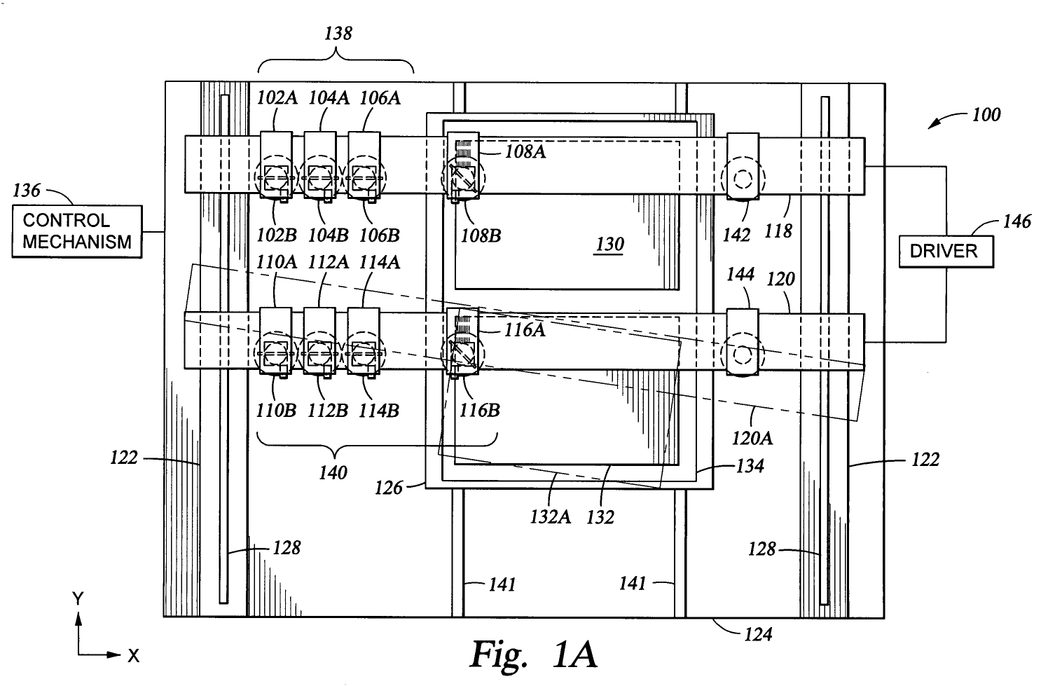

FIG. 1A illustrates a top view and FIG. 1B illustrates a side view of an embodiment of a system of the present invention which is designated generally by the reference numeral 100. The inkjet printing system 100 of the present invention, in an exemplary embodiment, may include print head assemblies 102, 104, 106, 108, 110, 112, 114, and 116, print head supports 118 and 120, and frame 122. Print head assemblies 102-116 may include drivers 102A, 104A, 106A, 108A, 110A, 112A, 114A, and 116A and print heads 102B, 104B, 106B, 108B, 110B, 112B, 114B, and 116B. Frame 122 may be supported on frame table 124, shown in FIG. 1B. The inkjet printing system 100 may also include a stage 126.

In the exemplary embodiment of FIGS. 1A and 1B, the first print head support 118 may support four print head assemblies which, from left to right, are designated by the reference numerals 102, 104, 106, and 108, respectively. The second print head support 120 may support four print head assemblies which, from left to right, are designated by the reference numerals 110, 112, 114, and 116, respectively. Although four print head assemblies are shown on print head support 120 in FIGS. 1A and 1B, it is important to note that any number of print head assemblies may be mounted on and/or used in connection with the print head support 120 (e.g., 2, 3, 5, 6, 7, etc. print head assemblies). The print head support 120 or print head assemblies 110-116 may include motors, carriages, and/or other drivers 110A-116A to move (e.g., laterally and/or rotationally) the print heads 110A, 112A, 114A, 116A.

In some embodiments, print head supports 118, 120 may be coupled to frame 122 via ball bearings, air bearings, magnetic bearings, or any other suitable bearings or coupling 128. Print head supports 118, 120 may be coupled so as to allow rotation of the supports so the supports may align with display objects 130 and 132, respectively, that may be skewed relative to each other or relative to the edge of the substrate 134. Display objects 130, 132 may include pixel wells. A display object 132 may be skewed such that it is not aligned with another display object 130 as shown in phantom as display object 132A (FIG. 1A).

Print head supports 118, 120 may be controlled by a single control mechanism 136 or individual control mechanisms. The control mechanism or mechanisms may send control signals so as to adjust print head supports 118 and 120 such that they are aligned with display objects 130 and 132, respectively. Print head supports 118, 120 may be movable via drivers 146 and may be rotatable or movable through several degrees of yaw along couplings 128 to align with display objects 130, 132 on substrate 134. In some embodiments, print head supports 118, 120 may be individually movable to separately align with display objects 130, 132. That is, print head support 118 may 5 align with display object 130 and print head support 120 may align with display object 132. In the exemplary embodiment of FIG. 1A, print head support 120 may be independently movable to align (depicted by a dashed outline and the reference numeral 120A) with a skewed display object 132A, which is skewed from display object 130. In the same or other embodiments, some or all print head supports 118, 120 may be separately movable and alignable to different display objects.

In the present invention, a display object is considered skewed from another display object if an edge of a first display object is not parallel to the corresponding edge of a second display object. For example, if the top edge of the first display object is parallel to the X-axis and the top edge of the second display object is not parallel to the X-axis, the display objects are considered skewed.

Print head supports 118, 120 may be spaced apart from one another by a predetermined distance so as to avoid contact between the print head supports as they are moved and/or rotated to align with different display objects. In one exemplary embodiment, print head supports 118, 120 may be spaced apart by a distance of approximately half of the length of a display object, although any suitable spacing may be used. In the same or other embodiments, print head supports 118, 120 may be capable of rotating though approximately plus or minus 1 degree of yaw. Greater or lesser degrees of yaw may be attainable, if appropriate. To achieve this rotation of print head supports, an end of a print head support may be capable of moving approximately 5 to 10 mm so that the print head support may align with a skewed display object. The other end of a print head support may also be moved a similar or different distance to achieve the desired rotation.

In one or more exemplary embodiments, each of the print heads 110B, 112B, 114B, 116B may be independently moveable in one or more lateral directions relative to another of the print heads 110B, 112B, 114B, 116B along the print head support 120. Print heads capable of independent lateral movement are described in previously incorporated U.S. patent application Ser. No. 11/019,967, filed Dec. 22, 2004 and entitled “APPARTUS AND METHODS OF AN INKJET HEAD SUPPORT HAVNG AN INKJET HEAD CAPABLE OF INDEPENDENT LATERAL MOVEMENT”. In another exemplary embodiment, each of the print heads 110B-116B may be independently rotatable relative to the print head support 120. The print head support 120, including the print head drivers 110A-116A and/or print head support driver 146 may be coupled logically (e.g., electrically) and/or mechanically with each of the print heads 110B-116B. The control mechanism 136 may be coupled to the print head support 120 and to each of the drivers 110A-116A and/or print heads 110B-116B so as to control and monitor the operation and movement of each of the print heads 110B-116B. In at least one embodiment print heads 102B-108B may be similarly configured to move independently in one or more lateral directions and/or to rotate independently relative to the print head support 118. The control mechanism 136 may control and monitor operation and movement of each of the print heads 102B-108B.

An example of a commercially available print head suitable for use with the present invention is the model SX-128, 128-Channel Jetting Assembly manufactured by Spectra, Inc. of Lebanon, NH. This particular jetting assembly includes two electrically independent piezoelectric slices, each with sixty-four addressable channels, which are combined to provide a total of 128 jets. The print head includes a number of nozzles which are arranged in a single line, at approximately 0.020″ distance between nozzles. The nozzles are designed to dispense drops from approximately 10 to 12 picoliters but may be adapted to dispense a broader range of drop sizes, for example, approximately 10 to 30 picoliters. Other print heads with differently sized and/or arranged nozzles may also be used.

In an exemplary embodiment, each of the print heads 110B, 112B, 114B, 116B can be positioned a predetermined distance from an adjacent print head so as to allow sufficient room for each print head to be moved laterally in both directions as well as to be rotated in order to perform any and/or all of the printing operations described herein. In one exemplary embodiment, the print heads 110B, 112B, 114B, 116B may be spaced by approximately 100 mm, although other spacings may be used. The print heads 102B-108B may be similarly positioned.

The substrate 134 may be supported by a stage 126. During a printing pass, the substrate 134 may be moved by the stage 126 under the print heads 102B-108B and 110B-116B as ink is dispensed onto the display objects 130-132. The stage 126 may be guided along rails 141. The stage 126 may also be coupled to the control mechanism 136 and the control mechanism 136 may control movement of the stage 126 (e.g., in directions along both the X-axis and the Y-axis). Note that FIG. 1A shows a selected X-axis and Y-axis frame of reference.

Additionally or alternatively, stage 126 may remain stationary during a printing pass. In some embodiments, print head supports 118 and/or 120 may move during a printing pass. In the same or other embodiments print heads 102B-116B may move individually or as print head sets 138 and 140 during a printing pass. As with stage 126, print head supports 118, 120 and print heads 102B-116B may be movable in directions along both the X-axis and the Y-axis.

Rails 141 may be supported on frame table 124. Frame 122 may be coupled to frame table 124, supported on frame table 124, independent of frame table 124, or may form a single unit with frame table 124. In the exemplary embodiment of FIGS. 1A and 1B, the frame 122 and frame table 124 may be adapted to prevent print head supports 118, 120 from shifting or vibrating during a print operation. As such, the frame table 124 and frame 122 may be constructed of any combination of vibration dampening materials such as granite, steel, cast iron, epoxy resin polymer composites, or any other suitable material.

As noted above, the system 100, in an exemplary embodiment, may include the control mechanism 136. The control mechanism 136 may be any suitable computer or computer system, including, but not limited to, a mainframe computer, a minicomputer, a network computer, a personal computer, and/or any suitable processing device, component, or system. The control mechanism 136 alternatively may comprise a dedicated logic circuit or any suitable combination of hardware and/or software. The control mechanism 136 may be adapted to control any of the print heads 102B-108B through the print head support 118 and/or any of the print heads 110B-116B through the print head support 120, including controlling the movement of each print head rotationally and in both positive and negative lateral displacement directions along the X-axis; the positive X-axis direction being indicated by the frame of reference arrow labeled X in FIG. 1A. The control mechanism 136 may also control any and all inkjet printing and maintenance operations capable of being performed by the print head supports 118, 120 and/or the print head assemblies 102-108, 110-116.

In some embodiments, the inkjet printing system may employ imaging systems 142, 144. Exemplary imaging systems for use in an inkjet print system are described in previously incorporated U.S. patent application Ser. No. 11/019,930, filed Dec. 22, 2004 and entitled “METHODS AND APPARATUS FOR ALIGNING PRINT HEADS”. Imaging systems 142, 144 may be mounted to print head supports 118, 120, for example, in a position conventionally used to carry a print head and may be aimed downward at the substrate 134. Such imaging systems 142, 144 may be used to determine an amount of skew of display objects 130, 132 on a substrate 134. Imaging systems 142, 144 may also be employed to align a substrate 134 on the stage 126 using alignment marks on the substrate 134, to help determine ink drop locations, and/or to help calculate offsets for print head positioning.

Alternatively, imaging systems 142, 144 may be mounted at or below the level of the stage 126, aimed upward and adapted to automatically focus on and capture images of the bottom of the print heads 102B-116B or the bottom of the substrate 134 (which has sufficient transparency so that the skew of display objects 130, 132 may be determined). In some embodiments, the imaging systems 142, 144 may be positioned below an opening in the stage 126 and/or in some embodiments, the imaging systems 142, 144 may be positioned adjacent the stage 126. The imaging systems 142, 144 may also be offset from the stage 126.

The imaging systems 142, 144 may be coupled to control mechanism 136 and/or may include software to communicate information, such as an amount of skew of a display object, to the control mechanism 136. The imaging systems 142, 144 may include one or more CCD-based camera, direct image sensor, or any other suitable sensor and/or detector device. The control mechanism 136 may be adapted to receive image data from the imaging systems 142, 144, process the image data, and determine display object skew, substrate alignment, or the like.

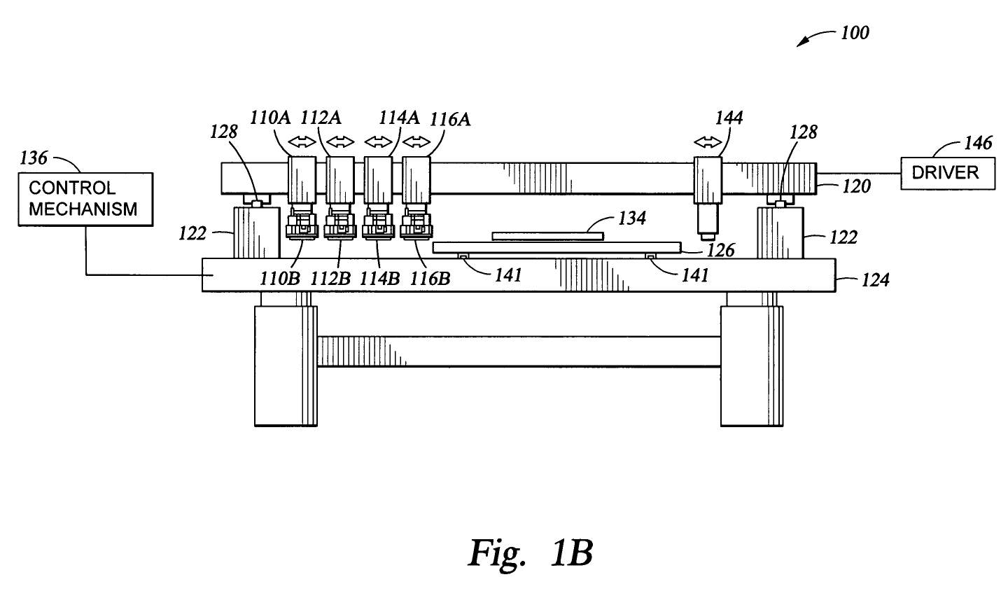

FIG. 2 depicts a top plan view of an exemplary embodiment of an apparatus according to the present invention. Inkjet printer 200 may include print head supports 204 and 206 and control mechanism 208. Movably mounted to print head supports 204 and 206 may be print head sets 210A-B, 212A-B, and 214A-B. Print head sets 210A-B, 212A-B, and 214A-B may include any number of print heads arranged along print head supports 204 and 206.

The control mechanism 208 may include a single control mechanism to control a plurality of print head supports 204, 206 or, in some embodiments, may include multiple control mechanisms which may each control one or more print head supports. Control mechanism 208 may be any suitable computer or computer system (or may otherwise be similar to control mechanism 136) and may also be adapted to control print head sets 210A-B, 212A-B, and 214A-B.

Print head supports 204 and 206 may be rotated or pivoted by drivers (not shown) to align with skewed display objects 216 and 218, respectively. Print heads of print head sets 210A-B, 212A-B, and 214A-B may be individually movable to align with pixel wells 220A-C and 222A-C within display objects 216 and 218 on substrate 202.

In some embodiments, multiple sets of print head sets may be aligned along print head supports 204 and 206. Each set may be movable and/or rotatable as a set to align individual print heads with any of pixel wells 220A-C and/or 222A-C, within display objects 216 and 218, respectively. In other embodiments, multiple sets of print head sets may be movable and/or rotatable as a group (e.g., print head sets 210A, 212A, and 214A movable as a single group). In still other embodiments, individual print heads within print head sets 210A-B, 212A-B, and 214A-B may be movable and/or rotatable to individually align with pixel wells 220A-C and 222A-C on display objects 216 and 218.

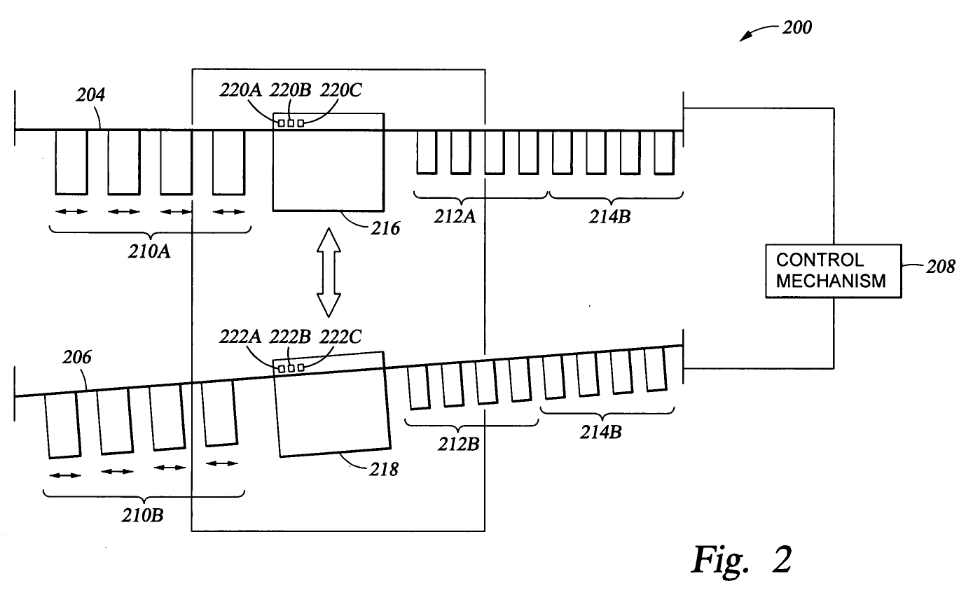

Turning to FIG. 3, a flowchart depicting an example embodiment of a method 300 of inkjet printing according to the present invention is illustrated. For convenience, the method 300 is described with reference to the inkjet printing system 100 of FIGS. 1A-1B. A similar method may be employed with the other inkjet printing systems described herein.

The example method 300 begins at step 302. In Step 304, print heads 102B, 104B, 106B, 108B may be arranged in a line along print head support 118 and print heads 110B, 112B, 114B, 116B may be arranged along print head support 120. Note that in some embodiments, the orientation and number of print heads may be different. In some embodiments, the number of print head supports may also be different.

In step 306, the print head supports 118, 120 may be adjusted so as to align with display objects 130, 132 on a substrate 134. Such an adjustment may compensate for a skewed display object, as shown, for example, by reference numeral 120A (in phantom) of FIG. 1A. Print head supports 118, 120A may separately align with different display objects along different axes such that print heads arranged along the first print head support 118 may be aligned to dispense material onto the first display object 130 and print heads arranged along the second print head support 120A may be aligned to dispense material onto a second display object 132A that is skewed from the first display object 130. That is, the print head supports 118, 120A may be aligned to dispense material onto display objects 130, 132A that do not have parallel edges.

In step 308, the substrate 134 positioned on the stage 126 may be moved in a print direction relative to the print head supports 118, 120. The stage 126 may be guided by and move along rails 141 arranged so as to carry the substrate 134 past print head supports 118, 120. In some embodiments, print head supports 118, 120 may have been moved from their original axes to align with display objects 130, 132 (or 132A). In the same or alternative embodiments, print heads 102B-116B may be moveable to align with one or more pixel wells within the display objects. That is, as the substrate 134 is moved in a print direction during a print operation, print heads 102B-116B may move laterally along print head supports 118, 120 such that the print heads are positioned to deposit material to a rank or file of pixel wells in a display object. In other words, if the edges of a display object are aligned parallel to both the X-axis and Y-axis, an associated print head support is aligned parallel to the X-axis, respectively, and the display object is moved in a print direction parallel to the Y-axis, no lateral movement of print heads of the print head support is necessary as the print pass is executed. However, if the edges of a display object are not parallel to the X-axis and Y-axis and the associated print head support is aligned with the display object, it may be necessary to move the print head assemblies 110, 112, 114, 116 laterally along the print head support 120 to track the pixel wells in a display object as the substrate 134 is moved in a print direction that is parallel to the Y-axis. Normally, the substrate 134 will be adjusted so that the first display object 130's edges are square with the print direction. However, if other display object 132 is skewed relative to the first display object 130, lateral shifting of print heads 110B, 112B, 114B, 116B during a print pass may be necessary to track the pixel wells of the skewed display object 132. In one particular embodiment, the substrate 134 is always adjusted so that the first display object 130's edges are square with the print direction so that the print heads 102B-108B need not move laterally (e.g., reducing the cost of the inkjet printing system 100).

In step 310, print heads 102B, 104B, 106B, and 108B (arranged along print head support 118) and print heads 10B, 112B, 114B, 116B (arranged along print head support 120) may deposit material onto display objects 130, 132 while the substrate 134 is moved in a print direction. Material may be concurrently dispensed from print heads arranged along different axes. Dispensed material may be ink of a single color per head, multiple colors of ink, or any other suitable material. The axes may be skewed to align with display objects that are not in alignment.

The method ends at step 312.

The control mechanism 136 may be adapted to perform one or more of the steps of method 300 (e.g., via suitable computer program code).

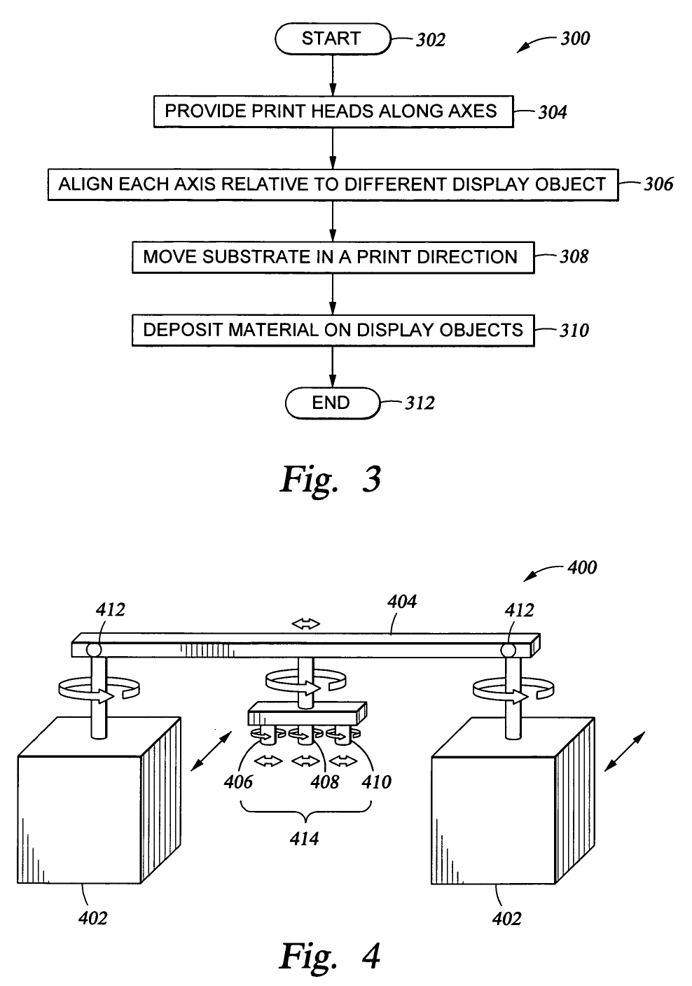

FIG. 4 illustrates a partial perspective view of an apparatus for inkjet printing in accordance with some embodiments of the present invention. The apparatus is designated generally by reference numeral 400. The exemplary apparatus may include frame 402, print head support 404, and print heads 406, 408, and 410.

In some embodiments, frame 402 may be operable to move the apparatus 400 fore and aft. In the same or other embodiments, a portion of frame 402 may be rotatable such that, when the portion of frame 402 is rotated, print head support 404 is caused to be aligned with a display object on a substrate beneath print heads 406, 408, 410.

Print head support 404 may be coupled to frame 402 via couplings 412, which may be ball bearings, air bearings, magnetic bearings, or any other suitable bearings or couplings. Print head support 404 may be movable along or about couplings 412 such that print head support 404 may be rotatable to align with a display object positioned beneath print heads 406, 408, 410 with or without movement by frame 402.

Print heads 406, 408, 410 may be individually movable and/or rotatable to align with individual pixel wells on a display object. Print heads 406, 408, and 410 may also be movable and/or rotatable as a print head set 414.

Although only three print heads 406, 408, 410 grouped into one print head set 414 have been described with respect to FIG. 4, any suitable number of print heads may be used and may be grouped into any suitable number of print head sets for use in inkjet printing. These print heads 406, 408, 410 and print head set 414 may be movable and/or rotatable individually or as a group and may be arranged along one or more print head supports 404. In some embodiments, an individual print head or print head set arranged along one print head support may be aligned with the same display object as an individual print head or set of print heads arranged along another parallel or non-parallel print head support.

The foregoing description discloses only particular embodiments of the invention; modifications of the above disclosed methods and apparatus which fall within the scope of the invention will be readily apparent to those of ordinary skill in the art. Further, although the above example methods are applied to only two print head supports 118 and 120 in FIGS. 1A and 1B and one print head support 404 in FIG. 4, one of ordinary skill in the art would understand that these methods may be applied to any number of print head supports, print heads, and imaging systems. Further, the present invention may also be applied to spacer formation, polarizer coating, and nanoparticle circuit forming.

Accordingly, while the present invention has been disclosed in connection with specific embodiments thereof, it should be understood that other embodiments may fall within the spirit and scope of the invention, as defined by the following claims.

What is claimed is:

1. A method comprising:
providing a plurality of sets of print heads, each set being disposed along a different axis; and
adjusting each axis relative to different display objects on a substrate.

2. The method of claim 1 further comprising:
moving the substrate in a print direction relative to the sets of print heads; and
depositing material on the display objects via the sets of print heads while the substrate is moved.

3. The method of claim 1 wherein adjusting each axis includes rotating each axis to align with different display objects.

4. The method of claim 1 further comprising:
moving the print heads individually to align with one or more pixel wells within the display objects.

5. The method of claim 1 wherein adjusting each axis includes each axis concurrently printing to differently skewed display objects.

6. The method of claim 1 wherein adjusting each axis relative to different display objects includes determining an amount of skew of the display objects on the substrate.

7. The method of claim 1 further comprising: sensing an amount of skew of the display objects on the substrate; and,
indicating an orientation of the display objects based on the sensed amount of skew.

8. The method of claim 7 wherein sensing an amount of skew of the display objects on the substrate includes capturing an image of the display objects on the substrate.

9. An apparatus comprising:
a plurality of sets of print heads;
a plurality of print head supports adapted to support the sets of print heads; and,
a control mechanism adapted to allow adjustment of the print head supports to align with different display objects on a substrate.

10. The apparatus of claim 9 wherein the control mechanism is adapted to allow adjustment of the print head supports to individually align with display objects on the substrate.

11. The apparatus of claim 9 further comprising:
a plurality of drivers adapted to adjust the print head supports to align with display objects on the substrate.

12. The apparatus of claim 9 wherein the print heads are adapted to move individually to align with one or more pixel wells within the display objects.

13. The apparatus of claim 9 further comprising:
a sensor to detect an amount of skew of the display objects on the substrate.

14. A system comprising:
an inkjet printer comprising;
a plurality of print heads grouped into a plurality of sets;
a stage adapted to move display objects on a substrate relative to the print heads during printing;
a plurality of print head supports adapted to support the sets of print heads above the stage; and,
a frame coupled to the plurality of print head supports and adapted to stabilize the print head supports during printing.

15. The system of claim 14 wherein the frame includes vibration dampening materials.

16. The system of claim 14 further comprising:
bearings adapted to adjustably couple the print head supports to the frame.

17. The system of claim 14 further comprising:
a control mechanism adapted to allow adjustment of the print head supports to align with display objects on the substrate.

18. The system of claim 17 wherein the control mechanism is adapted to allow adjustment of the print head supports to individually align with different display objects on the substrate.

19. The system of claim 14 further comprising:
a plurality of drivers adapted to adjust the print head supports to align with display objects on the substrate.

20. The system of claim 14 wherein the print heads are adapted to be moved individually to align with one or more pixel wells within the display objects.

21. The system of claim 14 further comprising:
a sensor to detect an amount of skew of the display objects on the substrate.
